(19) United States
(12) Patent Application Publication
(10) Pub. No.: US 2015/0193760 A1
(43) Pub. Date: Jul. 9, 2015

(54) IMAGING APPARATUS AND SALES DATA PROCESSING APPARATUS INCLUDING THE SAME

(71) Applicant: TOSHIBA TEC KABUSHIKI KAISHA, Tokyo (JP)

(72) Inventor: Hidehiro NAITO, Mishima Shizuoka (JP)

(21) Appl. No.: 14/592,048

(22) Filed: Jan. 8, 2015

(30) Foreign Application Priority Data
Jan. 9, 2014 (JP) 2014-002704

(51) Int. Cl. G06Q 20/20; H04N 5/33; G06Q 30/06; H04N 7/18

(52) U.S. Cl. CPC G06Q 20/208; H04N 7/183; H04N 5/33; G06Q 30/06

(57) ABSTRACT

A sales data processing apparatus includes an imaging unit configured to acquire an image of an item to be purchased that is placed in an imaging region and generate image data of the image, a light emitting unit configured to emit an infrared light towards the imaging region, and a control unit configured to identify the item based on the generated image data, and limit an amount of the infrared light that is incident on the imaging region when the imaging unit acquires the image.

### CROSS-REFERENCE TO RELATED APPLICATION

This application is based upon and claims the benefit of priority from Japanese Patent Application No. 2014-002704, filed Jan. 9, 2014, the entire contents of which are incorporated herein by reference.

### FIELD

Exemplary embodiments described herein relate to a sales data processing apparatus, an imaging apparatus, and a method for checking out an item to be purchased.

### BACKGROUND

In the related art, an imaging apparatus is used to read an object. In this imaging apparatus, if the object is placed near a reading window of the imaging apparatus, an imaging element such as a charge coupled device (CCD) or a complementary metal-oxide semiconductor (CMOS) of the imaging apparatus obtains an image of the object and generates image data, which may be edited or processed.

Such an imaging apparatus can be integrated in a sales data processing apparatus such as a POS terminal as an imaging unit. One type of the sales data processing apparatus detects an item to be purchased when a customer or a cashier places, for example, a barcode on the item near the reading window. Specifically, the barcode is read through the imaging unit, and information about the item is obtained from a storage device that stores merchandise sales data, based on the read barcode, and merchandise information, price information, or the like is displayed on a display unit. After the customer confirms that no error is in the displayed data of the transaction, the customer pays the charged amount and receives a receipt so as to complete the transaction.

One type of imaging apparatus employs an infrared light for various purposes such as detection of an object to be imaged. However, when the infrared light is emitted toward an imaging region of the imaging unit to detect the object, the infrared light reflected by the object may become incident on the imaging unit and negatively affect image data generated by the imaging unit.

### DESCRIPTION OF THE DRAWINGS

FIG. 1 illustrates a imaging apparatus according to a first exemplary embodiment.

FIG. 2 is a block diagram of the imaging apparatus.

FIG. 3 is a circuit diagram of a light emitting element of an infrared device in the imaging apparatus according to Example 1.

FIG. 4 is a timing chart of a monitor light control signal according to Example 1.

FIG. 5 is a circuit diagram of a light emitting element of an infrared device according to Example 2.

FIG. 6 is a timing chart of a monitor light control signal according to Example 2.

FIGS. 7A and 7B illustrate a positional relationship between a shutter and an optical path of an infrared light emitted by a light emitting element of an infrared device according to Example 3.

FIG. 8 is a schematic perspective view of a self POS which is used as a sales data processing apparatus according to a second embodiment.

FIG. 9 is a block diagram of the self POS.

FIG. 10 is a flow chart of a process carried out by a control unit of the self POS.

### DETAILED DESCRIPTION

Exemplary embodiments are directed to provide an imaging apparatus, a sales data processing apparatus, and a method for checking out an item to be purchased, that are capable of minimizing an amount of infrared light incident to an imaging unit.

In general, according to one embodiment, a sales data processing apparatus includes an imaging unit configured to acquire an image of an item to be purchased that is placed in an imaging region and generate image data of the image, a light emitting unit configured to emit an infrared light towards the imaging region, and a control unit configured to identify the item based on the generated image data, and limit an amount of the infrared light that is incident on the imaging region when the imaging unit acquires the image.

In the present embodiment, a detail of an imaging unit, a light emitting unit such as an infrared device an infrared device control unit, a driving circuit of the infrared device will be described. Furthermore, details of an image incorporation unit which incorporates image data of a subject generated by the imaging section into a storage unit will be described.

### First Exemplary Embodiment

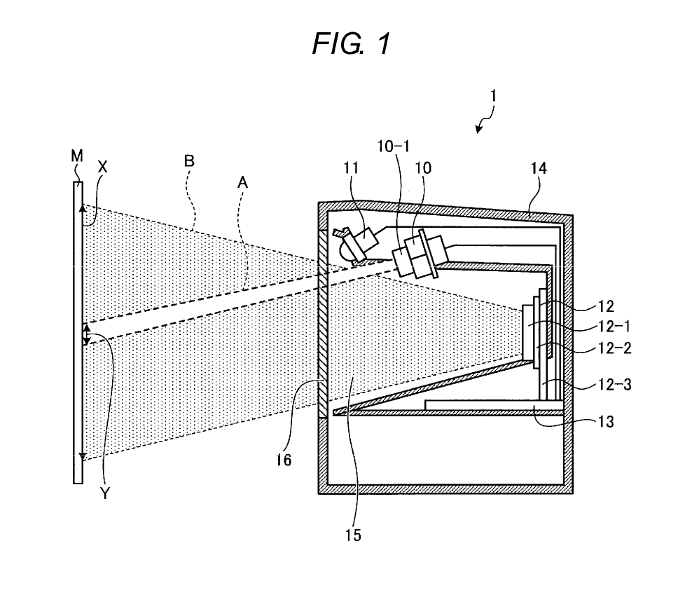

FIG. 1 schematically illustrates a reading apparatus according to a first exemplary embodiment. FIG. 1 is a top perspective view of an internal structure of the reading apparatus through a top plate and part of a casing of the reading apparatus.

A reading apparatus 1 of FIG. 1 mainly includes an infrared device 10, an illumination device 11, an imaging device 12, a control board 13, a box-shaped casing 14 in which the respective devices 10 to 13 are housed for protection, and a reading window 16 which is provided at an opening 15 of a front surface (a surface located on the left side in FIG. 1) of the casing 14.

The infrared device 10 includes a light emitting element 10-1 which emits infrared rays, and a light receiving element (not illustrated) which senses infrared rays. For example, a light emitting diode is used for the light emitting element 10-1, and, for example, a photodiode or a phototransistor is used for the light receiving element. The light emitting element 10-1 and the light receiving element are disposed so that light emitting surfaces and light receiving surfaces thereof are directed toward the reading window 16.

The illumination device 11 is a luminaire which uniformly illuminates merchandise held near the reading window 16. For example, a white light emitting diodes is used, and is disposed so that a light emitting surface thereof is directed toward the reading window 16.

The imaging device 12 includes a condensing lens 12-1, an imaging element 12-2, and an image control board 12-3. The condensing lens 12-1 causes an image of an item held near the reading window 16 to be formed in the imaging element 12-2, and includes a convex lens or the like. The imaging element 12-2 is an image sensor such as a charge coupled device (CCD) or a complementary metal-oxide semiconductor (CMOS). The imaging element 12-2 performs photoelectric conversion of light from the item with photoelectric elements which are disposed in a matrix, and outputs electrons collected at a capacitor or the like due to exposure, so as to generate an electrical signal. The image control board 12-3 starts or stops the imaging operation by the imaging element 12-2 according to a timing signal. During an imaging operation, the image control board 12-3 amplifies the electrical signal of an image output from the imaging element 12-2, further performs a predetermined signal processing such as A/D conversion thereon, generates digital data of the image (image data), and stores the image data in a buffer for each frame.

The reading window 16 is a transparent glass plate with low reflectance and is provided so as to be in close contact with the casing 14 at the opening 15 of the casing 14.

In the infrared device 10, as illustrated in FIG. 1, the light emitting surface of the light emitting element 10-1 is disposed to be directed toward the reading window 16, and the light receiving surface of the light receiving element is disposed to be directed toward the reading window 16. Thus, infrared light (which is light for observing a subject and is thus hereinafter referred to as monitor light) emitted from the light emitting surface of the light emitting element 10-1 passes through the reading window 16, and illuminates outside (that is, a specific region outside the casing 14 which is viewed over the reading window 16 from the inside of the casing 14) of the reading window 16.

In FIG. 1, an irradiation region of the monitor light is indicated by a dashed line A. In addition, the irradiation region is a region in which light with relatively high luminance, for example, exceeding average luminance passes. If merchandise M is held near the reading window 16, the monitor light reflected at the merchandise M is incident to the inside of the casing 14 through the reading window 16, and the reflected light is sensed by the light receiving element (not illustrated) of the infrared device 10.

When the merchandise M is held near the reading window 16, the merchandise M is irradiated with uniform illumination light, and the condensing lens 12-1 forms an image on the imaging element 12-2 with the light reflected at the merchandise M. In FIG. 1, a region (a reading range of the imaging element 12-2) in which an image of the merchandise M may be formed on the imaging element 12-2 is indicated by a dashed line B. Since the merchandise M is held only outside of the reading window 16, an outer region of the reading window 16 is a substantial reading range of the imaging element 12-2. If merchandise enters this region, an image thereof formed on the imaging element 12-2, and thus image data is generated. If the merchandise M is located at a distance illustrated in FIG. 1 from the reading apparatus 1, a range indicated by a line segment of an arrow X is a reading range of the imaging element 12-2. Since the monitor light is directed within the reading range of the imaging element 12-2, the reading range of the imaging element 12-2 and the irradiation range of the monitor light overlap each other in a range indicated by an arrow Y in FIG. 1.

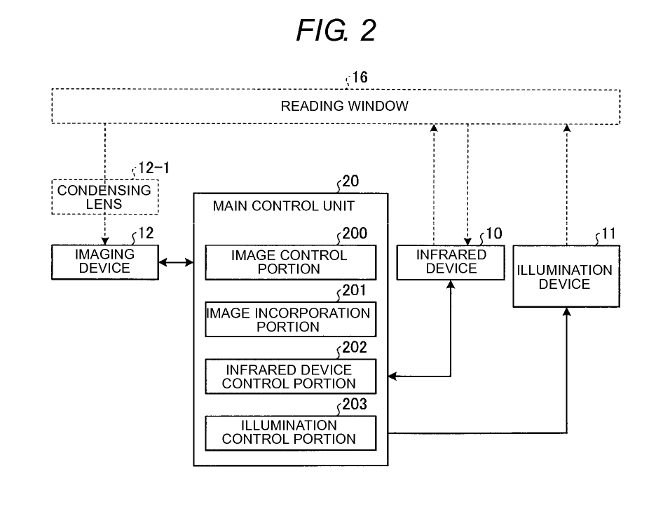

FIG. 2 is a control block diagram of the reading apparatus. FIG. 2 illustrates the infrared device 10, the illumination device 11, the imaging device 12 including the condensing lens 12-1, and a main control unit 20 mounted on the control board 13 of the reading apparatus 1 of FIG. 1. The main control unit 20 includes an imaging control portion 200, an image acquiring portion 201, an infrared device control portion 202, and an illumination control portion 203, and controls the respective constituent elements 10 to 12.

The imaging control portion 200 generates a timing signal (hereinafter, imaging timing signal) indicating starting or stopping of an imaging operation, and outputs the imaging timing signal to the imaging device 12 so as to control starting or stopping of imaging operation performed by the imaging element 12-2. Specifically, the control operation is performed as follows. The imaging timing signal has two different voltage levels (a low level and a high level), which is output to the imaging device 12. If the imaging timing signal is switched from a low level to a high level, the imaging element 12-2 starts an imaging operation, and if the imaging timing signal is switched from a high level to a low level, the imaging element 12-2 stops the imaging operation.

In the present exemplary embodiment, with a detection signal from the infrared device control portion 202 as a trigger, the imaging control portion 200 switches the imaging timing signal to a high level so as to instruct star of imaging. If the reading apparatus 1 is in a standby mode, first, the reading apparatus 1 is recovered from the standby mode according to a detection signal from the infrared device control portion 202, and then the imaging control portion 200 switches the imaging timing signal to a high level. With a process end signal from the image incorporation portion 201 as a trigger, the imaging control portion 200 switches the imaging timing signal to a low level so as to instruct end of imaging.

The image incorporation portion 201 acquires image data from the imaging device 12 for each frame, performs an image analyzing process after developing the acquired image data on an internal memory or the like, and performs a identification process, for example, through extracting information on feature amount of merchandise, although not described in detail. If the identification process ends, the end signal is output to the imaging control portion 200.

The infrared device control portion 202 generates a monitor light control signal in synchronization with the imaging timing signal for starting or stopping the imaging, generated by the imaging control portion 200, and controls monitor light from the light emitting element 10-1. For example, monitor light is turned off with rising of a signal indicating start of the imaging in the imaging timing signal as a trigger, and the monitor light is turned on with falling of a signal indicating stop of the imaging as a trigger.

The monitor light control signal is a control signal for preventing the monitor light from reaching the reading range such as controlling turning-on and turning-off of the monitor light, changing output of the monitor light, opening and closing a shutter for blocking an optical path of the monitor light, changing a direction (a direction of a light emitting element surface) of the infrared sensor for directing an irradiation direction of the monitor light outward the reading range, or the like.

The infrared device control portion 202 monitors output from the light receiving element of the infrared device 10. If output indicating sensing of a subject is detected, a detection signal is output to the imaging control portion 200. On the other hand, if there is no output indicating sensing of a subject from the light receiving element for a specific time, the reading apparatus 1 enters a standby mode, and stops the supply of power to all electronic components except for necessities such as the infrared device 10 or an infrared detection function.

When the infrared device control portion 202 detects output indicating sensing of a subject, if the reading apparatus 1 is in a standby mode, first, the main control unit 20 is recovered from the standby mode, and then the imaging control portion 200 detects a detection signal from the infrared device control portion 202.

The illumination control portion 203 sends control signals indicating turning-on and turning-off to the illumination device 11 in synchronization with the imaging timing signal generated by the imaging control portion 200, so as to control the illumination device 11. For example, a signal indicating start of turning-on is sent to the illumination device 11 with rising of a signal indicating start of imaging in the imaging timing signal as a trigger, and a signal indicating turning-off is sent to the illumination device 11 with falling of a signal indicating end of imaging in the imaging timing signal as a trigger. In the above-described manner, turning-on and turning-off of the illumination device 11 are controlled.

Next, each control target of the monitor light control signal will be described as Example.

### Example 1

In Example 1, the infrared sensor control portion minimizes a light emission amount by reducing output of monitor light, so as to prevent the monitor light from reaching a reading range.

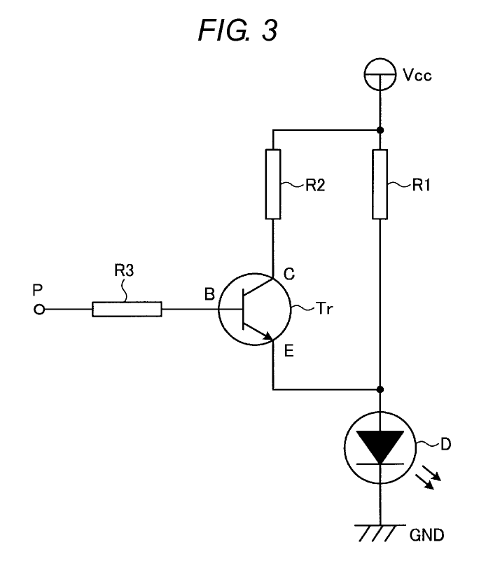

FIG. 3 illustrates a driving circuit of the light emitting element 10-1 of the infrared device 10 according to Example 1.

The driving circuit of FIG. 3 includes an infrared light emitting diode D, an NPN type bipolar transistor Tr, and three resistors R1-R3.

The resistor R1 is used for the light emitting diode D to emit light in a low output level.

The resistor R2 is used to change a value of a current which flows through the light emitting diode D.

The resistor R3 is used to adjust a current of a base B of the NPN type bipolar transistor Tr.

The monitor light control signal is input to an input terminal P of the circuit.

If a voltage of 0 V indicating an output restriction signal is applied to the input terminal P, a current does not flow through the base B of the NPN type bipolar transistor Tr, and thus a current does not flow between a collector C and an emitter E. Therefore, a small current defined by the resistor R1 flows into the light emitting diode D, so that monitor light with a low output level is obtained.

On the other hand, if a power supply voltage indicating an output opening signal is applied to the input terminal P, a predetermined level of base current flows through the base B of the NPN type bipolar transistor Tr, and thus a current flows between the collector C and the emitter E. Therefore, a current which flows into the light emitting diode D is increased as the resistor R2 is connected in parallel to the resistor R1, and the monitor light is switched from a low output level to a high output level. Here, a value of the resistor R2 is selected so that a rating current flows.

If influence of monitor light on a captured image cannot be disregarded, an output level of monitor light has to be reduced to an extent at which influence of reflection of the monitor light may be disregarded in a captured image (or imaging data) obtained by imaging a subject such as merchandise. To determine this output level, reflection of monitor light is tested in advance, and an output level which does not hinder analysis of image data is determined. For example, an output level of a light emitting diode D is set constant, and merchandise, which is a subject, is irradiated with the monitor light. Then, imaging is performed in a state in which the monitor light is applied to the merchandise. This procedure is repeatedly performed multiple times while an output level gradually is reduced, and an identification rate of the merchandise through generated image data is calculated with respect to each image data item. Then, an output level of high identification rate (for example, an identification rate exceeding 80%) is set to a lower output level of the light emitting diode, and values of the resistors R1 and R2 are determined accordingly.

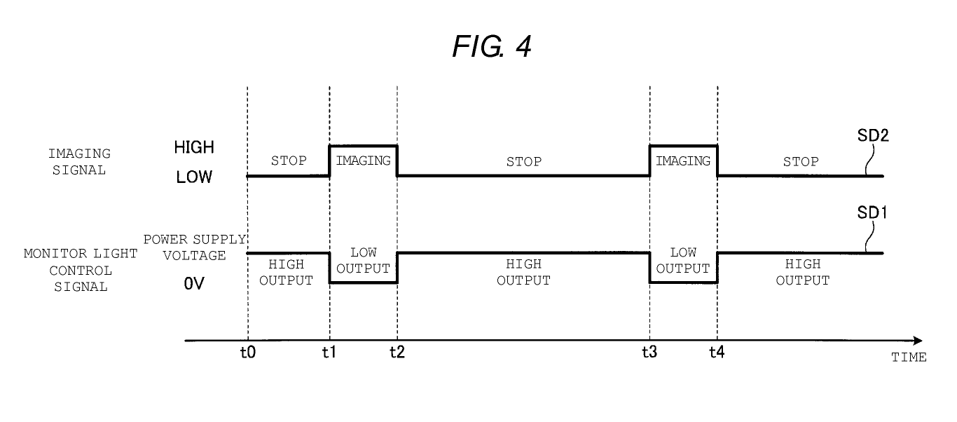

FIG. 4 illustrates a timing chart of the monitor light control signal. A horizontal axis of the timing chart shows time, and a vertical axis shows a level of an input voltage at the input terminal P and a level of an imaging timing signal SD2.

In FIG. 4, a monitor light control signal SD1 and the imaging timing signal SD2 are shown in parallel for comparison thereof. The level of the imaging timing signal SD2 has two states, that is, a high level (during imaging) and a low level (imaging stopped).

As illustrated in FIG. 4, the monitor light control signal SD1 has a signal level opposite to a signal level of the imaging timing signal SD2 at each time point in accordance with a variation in the imaging timing signal SD2.

In the present example, the infrared device control portion 202 reverses the imaging timing signal output from the imaging control portion 200 with an inverter or the like and uses the reversed imaging timing signal as the monitor light control signal, performs voltage level conversion of the monitor light control signal so that a maximum voltage value is a power supply voltage and a minimum voltage value is 0 V, and outputs the signal to the input terminal P of the light emitting element 10-1.

When FIG. 4 is described in detail, the imaging timing signal SD2 has a low level (that is, an imaging stop state) from the time point t0 to the time point t1, and, at this time, the monitor light control signal SD1 has a power supply voltage level (high output light emission). From the time point t1 to the time point t2, the imaging timing signal SD2 has a high level (during imaging), and the monitor light control signal SD1 has a ground voltage level (low output light emission). From the time point t2 to the time point t3, the imaging timing signal SD2 has a low level (imaging stopped), and the monitor light control signal SD1 has a power supply voltage level (high output light emission). After that time, the respective signals SD1 and SD2 reverse signal levels at timings of the time point t4 and the time point t5.

As mentioned above, the monitor light control signal SD1 is set in accordance with the level of the imaging timing signal SD2, so that the monitor light control signal SD1 has a signal level opposite to a signal level of the imaging timing signal SD2 at each time point.

In the above-described manner, the infrared device 10 is operated as follows.

In switching of the signal from a ground voltage level to a power supply voltage level, the light emitting element 10-1 is operated with a current having a value which is the optimum to operation. In this way, the infrared device 10 outputs an output signal having a level that is required to detect the monitor light. In switching of the signal from a power supply voltage level to a ground voltage level, the light emitting element 10-1 is operated with a current having a low value. In this way, influence of monitor light during imaging is excluded.

Next, an operation in the reading apparatus 1 will be described according to the timing chart.

From the time point t0 to the time point t1, the imaging timing signal SD2 is at a low level, and thus the imaging element 12-2 stops imaging. This indicates that there is no merchandise in a reading range (the reading range B of FIG. 1).

During that time, the infrared device control portion 202 outputs a signal with a power supply voltage level to the infrared device 10 as the monitor light control signal SD1. Consequently, the light emitting element 10-1 emits a monitor light at a high level, and applies the monitor light having a level with which merchandise may be detected, into the reading range.

The time point t1 is a state in which merchandise enters the reading range. If the merchandise enters the reading range, the light receiving element of the infrared device 10 senses the monitor light reflected on the merchandise, and the infrared device control portion 202 receives a detection signal thereof. The infrared device control portion 202 determines that the merchandise is in the reading range when a detection signal level exceeds a predetermined level, and outputs the detection signal to the imaging control portion 200. The imaging control portion 200 switches the imaging timing signal SD2 to a high level. Substantially at the same time as this, the infrared device control portion 202 switches the monitor light control signal SD1 to a ground voltage level.

In other words, the imaging device 12 starts imaging at the time point t1, and, during the imaging, the light emitting element 10-1 emits the monitor light having a low level.

At the time point t2, for example, the image incorporation portion 201 notifies the imaging control portion 200 of end of an image identification process of the merchandise, and then the imaging control portion 200 switches the imaging timing signal SD2 to a low level. The infrared device control portion 202 switches the monitor light control signal SD1 to a power supply voltage level in accordance with the switching of the imaging timing signal SD2 performed by the imaging control portion 200.

That is, at the time point t2, the imaging device 12 stops imaging, and, during that time, the light emitting element 10-1 emits monitor light having a high level toward the reading range.

After that time, signal levels of the imaging timing signal SD2 and the monitor light control signal SD1 are switched in the same manner.

As described above, in the present example, an output level of monitor light is reduced by changing a value of a current which flows through the light emitting diode. However, the present exemplary embodiment is not limited to this method, and other methods may be used. For example, the light emitting diode may be operated using a pulse width modulation (PWM) signal, and the light emitting diode emits light by changing a duty ratio (pulse width) of the PWM signal, that is, the light emitting diode emits light by setting a duty ratio to 100% for high-level light emission, and the light emitting diode emits light by setting a duty ratio to, for example, 10% or less for low-level light emission. In the above-described manner, a light emission time of the light emitting diode is reduced, and thus an average light emission amount may be reduced. As a result, an output level of monitor light decreases.

As described above, in the present example, monitor light is prevented from reaching a reading range of the imaging element by reducing an output level of the monitor light during imaging. Consequently, reflection of monitor light in imaging data may be excluded or may be considerably reduced.

### Example 2

In Example 2, the infrared sensor control unit prevents monitor light from reaching a reading range by turning off the light emitting element.

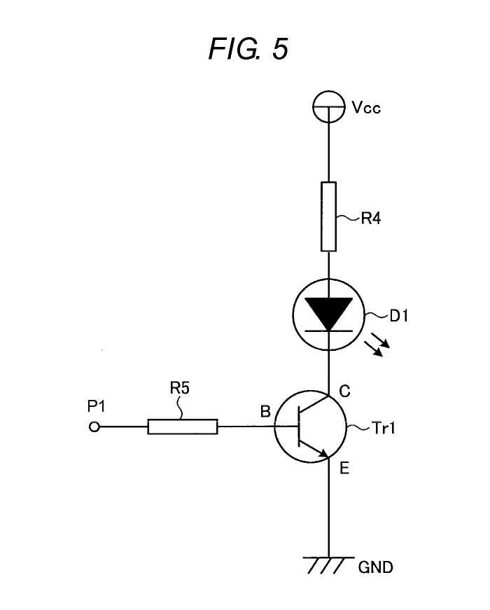

FIG. 5 illustrates a driving circuit of the light emitting element 10-1 of the infrared device 10 of Example 2.

The driving circuit of FIG. 5 includes an infrared light emitting diode D1, an NPN type bipolar transistor Tr1, and two resistors R4 and R5.

The resistor R4 is used to operate the light emitting diode D1 with a rating current and voltage.

The resistor R5 is used to adjust a current of a base B of the NPN type bipolar transistor Tr1.

The monitor light control signal is input to an input terminal P1.

If a voltage of 0 V, indicating an output restriction signal, is applied to the input terminal P1, a current does not flow through the base B of the NPN type bipolar transistor Tr1, and thus a current does not flow between a collector C and an emitter E. Therefore, a current does not flow through the light emitting diode D1, and thus the light emitting diode D1 does not emit light.

On the other hand, if a power supply voltage, indicating an output opening signal, is applied to the input terminal P1, a base current flows through the base B of the NPN type bipolar transistor Tr1, and thus a current flows between the collector C and the emitter E. Therefore, a rating current flows through the light emitting diode D1, and thus the light emitting diode D1 emits light.

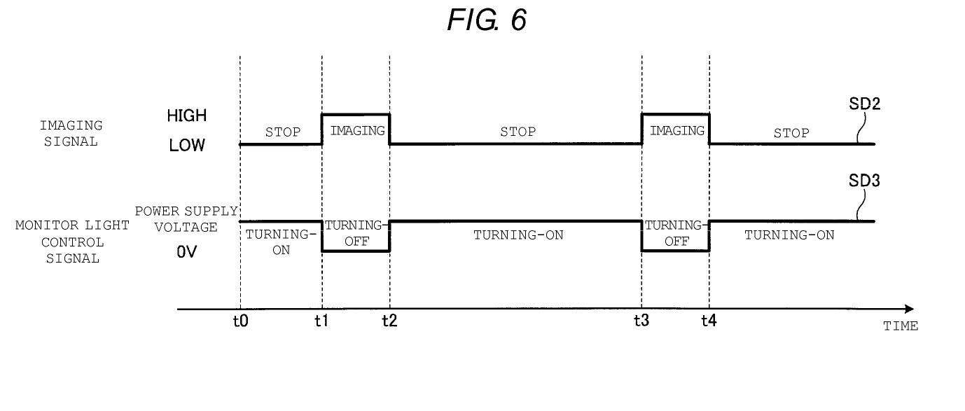

FIG. 6 is a timing chart of the monitor light control signal. A horizontal axis of the timing chart shows time, and a vertical axis shows a level of an input voltage at the input terminal P1 and a level of an imaging timing signal SD2.

In FIG. 6, a monitor light control signal SD3 and the imaging timing signal SD2 are shown in parallel for comparison. The level of the imaging timing signal SD2 has two levels, that is, high level (during imaging) and low level (imaging stopped).

The timing chart of FIG. 6 is the same as the timing chart of FIG. 4 in many aspects, and thus only different aspects will be described here.

As illustrated in FIG. 6, in the monitor light control signal SD3, the “high output” in the monitor light control signal SD1 of FIG. 4 is replaced with “turning-on”, and “low output” is replaced with “turning-off”. Values of each level of the monitor light control signal SD3 is the same as values of each level of the monitor light control signal SD1, but a light emission state is different due to a difference in the driving circuit of the light emitting element.

As illustrated in FIG. 6, the light emitting diode does not emit light and is turned off from the time point t1 to the time point t2 and from the time point t3 to the time point t4, during which the imaging is carried out.

In Example 2, irradiation with monitor light is completely stopped while the imaging element performs the imaging. Therefore, in Example 2, monitor light may be completely prevented from reaching a reading range of the imaging element. Consequently, reflection of monitor light in imaging data may be completely excluded.

### Example 3

In Example 3, the infrared sensor control portion prevents monitor light from reaching a reading range by moving a blocking object in an optical path of the monitor light.

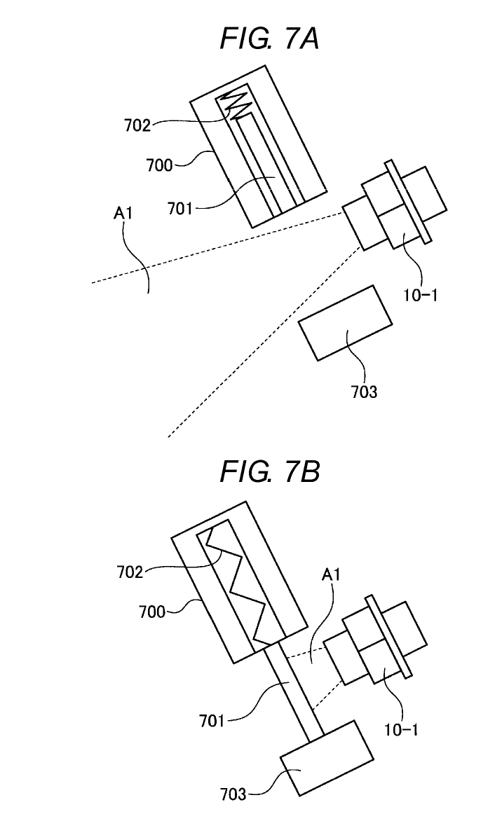

FIGS. 7A and 7B illustrate a positional relationship between a shutter and an optical path of the monitor light. FIGS. 7A and 7B schematically illustrate a shutter mechanism.

In FIGS. 7A and 7B, the shutter mechanism includes a shutter storage unit 700 having a slot, a shutter (light blocking plate) 701 formed of a magnetic body which may freely move out of and into the slot of the shutter storage unit 700, a tension spring 702 which is installed in the slot and at one end of the light blocking plate 701, and an electromagnet 703, which is disposed in a direction in which the light blocking plate 701 moves outside the slot. The light blocking plate 701 has a predetermined area so as to completely block the monitor light. The electromagnet 703 are operated according to On and Off signals.

FIG. 7A illustrates a state in which a current does not flow through the electromagnet 703, and the light blocking plate 701 is stored in the shutter storage unit 700, being held by the tension spring 702.

FIG. 7B illustrates a state in which a current flows through the electromagnet 703, and the light blocking plate 701 is pulled out by a magnetic force of the electromagnet 703, and thus completely blocks the monitor light (a range A1 indicated by a dashed line of FIGS. 7A and 7B) at this position. At this time, if the tension spring 702 is biased and the current does not flow through the electromagnet 703, the light blocking plate 701 is drawn into the shutter storage unit 700 by a biasing force of the tension spring 702 so that the light blocking plate 701 returns to the state shown in FIG. 7A.

In the shutter mechanism illustrated in FIGS. 7A and 7B, an On signal for turning on the electromagnet 703 and an Off signal for turning off the driving may be output as On and Off monitor light control signals from the infrared sensor control portion.

In the present example, the shutter mechanism has a single light blocking plate and a single electromagnet. However, the shutter mechanism may be a focal plane shutter which controls a shutter by making two light blocking films travel, a lens shutter which blocks the monitor light by circularly combining a plurality of shutter blades, a liquid crystal shutter which controls transmission and blocking of light by changing a molecular arrangement through control of a voltage, or the like.

The present example relates to a configuration in which the light emitting element is not moved, and the blocking object is moved, but is not limited thereto, and may relate to a configuration in which the light emitting element instead of the blocking object is moved, or both of the blocking object and the light emitting element are moved. If the light emitting element is moved, an optical path of the monitor light may not reach an imaging region of the imaging element.

In Example 3, the monitor light is blocked by the light blocking plate while the imaging element performs the imaging. Therefore, in Example 3, the monitor light may be prevented from reaching a reading range of the imaging element. Consequently, influence of the monitor light on imaging data may be completely excluded.

### Second Exemplary Embodiment

In a second exemplary embodiment, the function of the main control unit of the reading apparatus of the first exemplary embodiment is achieved by a control unit of a merchandise sales data processing apparatus.

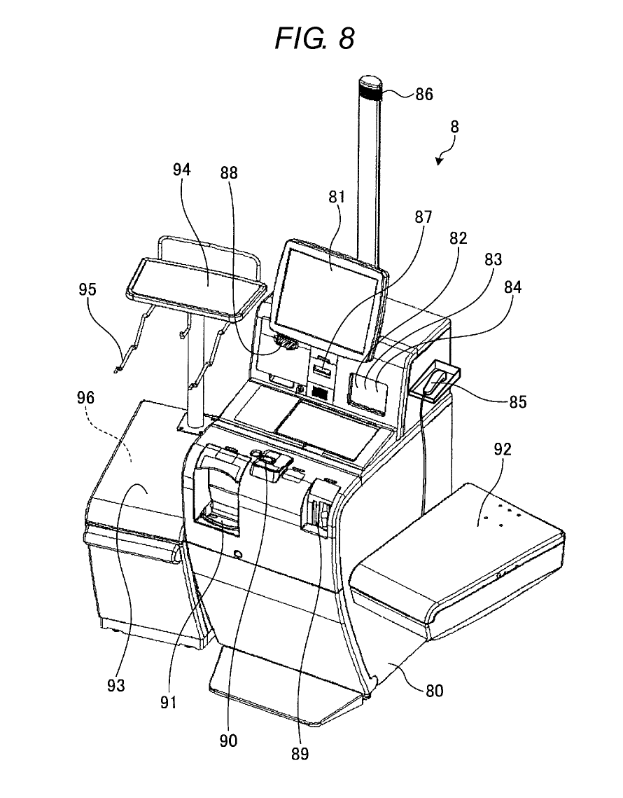

FIG. 8 is a schematic perspective view of a self POS used as a merchandise sales data processing apparatus.

A self POS 8 of FIG. 8 has a touch input type display 81 at an upper part of a main body 80. The display 81 is a liquid crystal display having a touch sensor on a screen. The display 81 displays an input screen for inputting merchandise information, a checking screen for checking merchandise candidates or merchandise information of merchandise read through a reading apparatus, and a checkout screen for checking a total price of merchandise, a paid amount, a change amount, or the like.

A reading apparatus 83 in which a reading window 82 is disposed toward a user is provided under the display 81. An infrared device 84 which detects merchandise held near the reading window 82 is disposed inside the reading apparatus 83, part of which is allowed to be viewed from the reading window 82, so that a light emitting surface and a light receiving surface of the infrared device 84 are disposed toward the reading window 82.

The reading apparatus 83 has the same structure as the structure of the reading apparatus according to the first exemplary embodiment. Therefore, if merchandise is held near the reading window 82, the reading apparatus 83 images the merchandise with a built-in imaging element and transmits imaging data to a control unit of the main body 80.

Although not illustrated in FIG. 8, an illumination device which uniformly illuminates the merchandise near over the reading window 82 with light is disposed inside the reading apparatus 83.

The self POS 8 has a hand scanner 85 on the front right side of the main body 80.

A pole is provided at a top plate of the main body 80, and a warning lamp 86, which is turned on when there is an abnormality in an operation of the self POS 8 or when a salesperson is called, is provided at an upper part of the pole.

The self POS 8 has a card insertion port 87 into which a point card or a credit card is inserted, at a center of the main body 80. A receipt issuing port 88 for issuing a receipt is provided on a left side of the card insertion port 87. A printer is mounted in the main body 80, and a receipt printed by the printer is output from the receipt issuing port 88.

The self POS 8 includes a bill input/output port 89 for a customer to insert bills or receive change bills, a coin input port 90 for the customer to input coins during settlement, a coin output port 91 for the customer to receive change coins, and the like at a middle part of the main body 80.

The self POS 8 includes a merchandise placing table 92 for a customer to place merchandise which has not been checked out, on the front right side of the main body 80, and a merchandise placing table 93 for the customer to place checked-out merchandise, on the front left side thereof.

A pole is erected on an upper surface of the merchandise placing table 93, and a temporarily placing table 94 for a customer to temporarily place checked-out merchandise is provided at an upper part of the pole. A bag hanging hook 95 for hanging a bag is provided in front of the temporarily placing table 94. A measurement device 96, which measures a total weight applied to the merchandise placing table 93, the bag hanging hook 95, and the temporarily placing table 94, is provided inside the merchandise placing table 93.

Next, a functional configuration of the self POS 8 will be described.

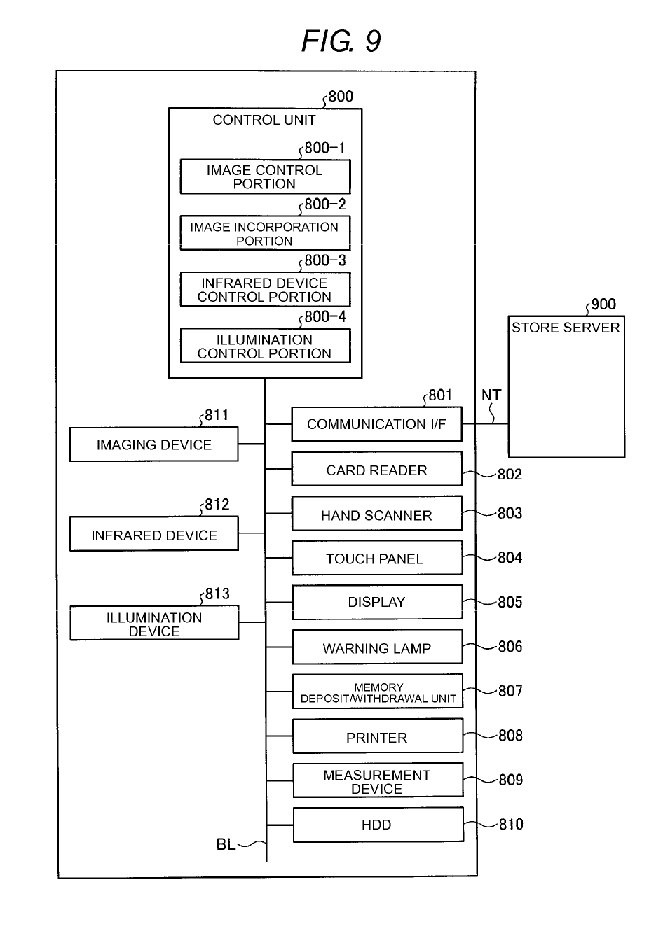

FIG. 9 illustrates a functional blocks of the self POS. The self POS 8 has a control unit 800 includes a CPU and a ROM and a RAM (none illustrated) which function as a storage section. The ROM stores various programs executed by the CPU or various data items. The RAM temporarily stores data or a program when the CPU executes various programs.

The control unit 800 is connected to a communication I/F 801, a card reader 802, a hand scanner 803, a touch panel 804, a display 805, a warning lamp 806, a money deposit/withdrawal unit 807, a printer 808, a measurement device 809, an HDD 810, and apparatuses such as the following reading apparatus, via various interfaces or a bus BL.

In the same manner as in the reading apparatus according to the first exemplary embodiment, the reading apparatus includes an imaging device 811, an infrared device 812, an illumination device 813, and the control unit 800 which includes an imaging control portion 800-1, an image incorporation portion 800-2, an infrared device control portion 800-3, and an illumination control portion 800-4.

The imaging device 811 includes a lens, an imaging element, an imaging control board, and the like.

The infrared device 812 includes a light emitting unit and a light receiving unit. An infrared light emitting diode is used for the light emitting unit, and an infrared photodiode or the like is used for the light receiving unit.

A white light emitting diode is used for the illumination device.

The control unit 800 controls the entire system of the self POS 8 including the devices 801-813.

The card reader 802 reads information on a point card or a credit card which is inserted into the card insertion port 87, and notifies the control unit 800 of the read information.

The hand scanner 803 reads barcode information of merchandise and notifies the control unit 800 of the read information.

The touch panel 804 notifies the control unit 800 of a button selected or information input by a customer through various screens displayed on the display 805.

The display 805 displays an input screen for inputting merchandise information, a checking screen for checking merchandise candidates or merchandise information of merchandise read through the reading apparatus, and a checkout screen for checking a total price of merchandise, a paid amount, a change amount, or the like.

The warning lamp 806 is turned on when there is an abnormality in an operation of the self POS 8 or when a salesperson is called.

The money deposit/withdrawal unit 807 manages deposit and withdrawal of bills or coins in the bill input/output port 89, the coin input port 90, the coin output port 91, and the like.

The printer 808 prints a receipt after the checkout processing is performed, and guides the receipt to the receipt issuing port 88.

The measurement device 809 measures a total weight applied to the merchandise placing table 93, the bag hanging hook 95, and the temporarily placing table 94, and notifies the control unit 800 of a calculation result.

The HDD 810 stores a merchandise master (merchandise sales data) (not illustrated). The merchandise master includes various merchandise information pieces such as merchandise names, unit prices, and set weight ranges in which a weight range of merchandise is set, in correlation with merchandise codes.

The control unit 800 may perform communication with a store server 900, which is connected to a network NT such as a local area network (LAN) via the communication I/F 801, or an attendant terminal (not illustrated) for a salesperson (attendant) who assists each process of self checking. The store server 900 generally manages merchandise sales registration processing and the like, which are performed in a single or a plurality of self POSs 8 provided in a store.

The store server 900 may update or edit data of the merchandise master by performing data communication with the self POS 8 via the communication I/F 801 and the network NT.

Next, a more specific functional configuration of the self POS 8 will be described. The control unit 800 of the self POS 8 executes a program according to the present exemplary embodiment stored on the ROM, on the RAM, so as to function as the imaging control portion 800-1, the image incorporation portion 800-2, the infrared sensor control portion 800-3, and the illumination control portion 800-4, as illustrated in FIG. 9.

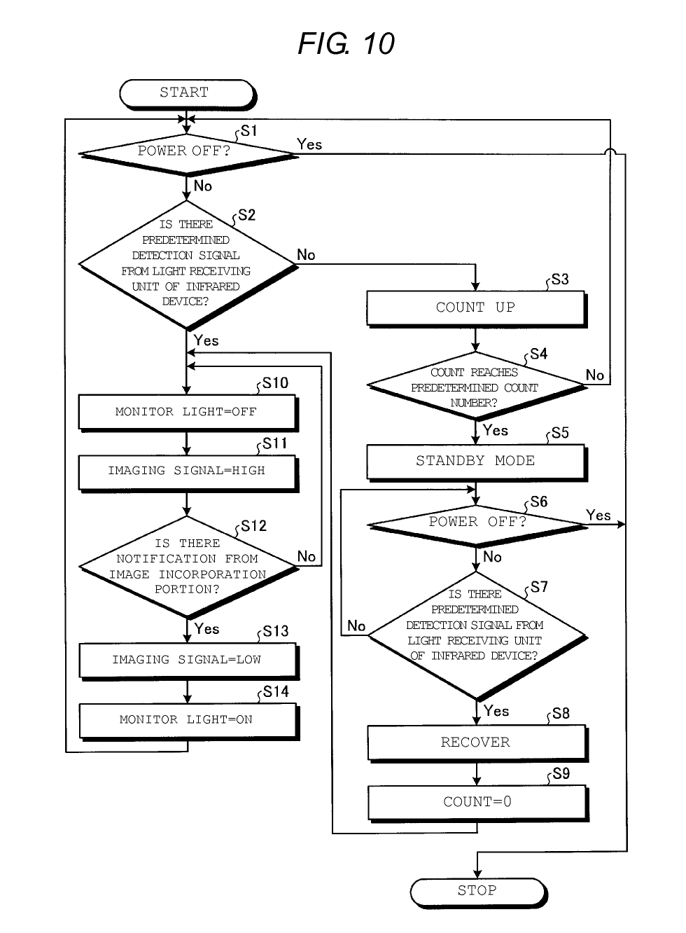

FIG. 10 illustrates a process flow of the program of the present exemplary embodiment executed by the control unit 800 of the self POS 8.

First, if a user presses a power button of the self POS 8, a basic program is activated so as to perform an initial setting process such as initialization, and then the present program is activated.

In the present program, first, whether or not the main body 80 is powered off is determined (step S1). If a determination result is Yes, the process performed by the present program is finished.

If the determination result in step S1 is No, whether or not there is a predetermined detection signal from the light receiving element of the infrared device 812 is determined (step S2). Here, it is determined whether or not there is a predetermined detection signal, for example, whether or not the light receiving element senses light having a level that is equal to or higher than a predetermined level.

If a determination result in step S2 is No, a counter is incremented by “+1”, and an elapsed time is counted up (step S3).

Next, whether or not a count reaches a predetermined count number is determined (step S4).

If a determination result in step S4 is No, the process from step S1 is repeatedly performed, and the counter in step S3 is further incremented by “+1”.

Consequently, when a count continuously increases, and reaches a predetermined count number, a determination result in step S4 is Yes, and the reading apparatus 83 is switched to a standby mode (step S5).

Then, whether or not the main body 80 is powered off is determined (step S6). If a determination result is Yes (Yes at step S6), the process performed through the present program is finished.

If the determination result in step S6 is No (No at step S6), whether or not there is a predetermined detection signal from the light receiving element of the infrared device 812 is determined (step S7). Also in this determination, in the same manner as in step S2, it is determined that there is the predetermined detection signal, for example, if the light receiving element senses light having a level that is equal to or higher than a predetermined level.

If a determination result in step S7 is No, the process goes back to step S6.

If a determination result in step S7 is Yes, the reading apparatus 83 is recovered from the standby mode (step S8), and the counter is reset to “0” (step S9).

A process subsequent to step S9 is the same as the process which is performed when a determination result in step S2 is Yes.

In other words, the monitor light is turned off (step S10), and an imaging signal is switched to a high level (step S11). At this time, the imaging signal is turned on, and imaging is started.

Then, whether or not there is a notification from the image incorporation portion 800-2 is determined (step S12). Here, it is determined that there is the notification if a signal indicating that an image analysis process ends is received from the image incorporation portion 800-2.

If a determination result in step S12 is Yes, an imaging signal is switched to a low level (step S13), and monitor light is turned on (step S14). In other words, the imaging is stopped at this timing, and the monitor light is applied.

Then, the flow returns to the process in step S1, and processes are repeatedly performed from step S1 in the same manner.

As mentioned above, the program of the present exemplary embodiment is executed, and thus the self POS is operated as follows.

Since the monitor light is not applied during the imaging of merchandise, image data that correspond only to the illumination light that is uniformly applied to and reflected on the merchandise may be acquired. That is, there is no deficiency of some image information or no acquisition of wrong information, and thus a suitable merchandise image may be generated as data. Therefore, merchandise may be accurately determined in a subsequent image analyzing process, and thus a merchandise reading process may be more reliably performed.

Consequently, based on an object of merchandise which is identified through the image analysis process carried out by the image incorporation portion 800-2, the control unit 800 extracts merchandise sales data corresponding to the object from the merchandise master of the HDD 810, and displays a checking screen on the display 805 along with merchandise candidates or merchandise information. A user selects matching merchandise from the merchandise candidates. The control unit 800 controls the display 805 to display an checkout screen on which a price of the selected merchandise or the like is displayed, so as to perform merchandise checkout processing. As the checkout processing, there is cash checkout processing in which cash is input to the money deposit/withdrawal unit 807 from the bill input/output port 89 or the coin input port 90 and the change is received from coin output port 91, and card checkout processing in which information is read from a point card or a credit card via the card reader 802 and the control unit 800 is notified of the information so as to perform merchandise checkout.

As mentioned above, in the present exemplary embodiment, monitor light may be prevented from reaching a reading range of the imaging element. Thus, reflection of monitor light in imaging data may be excluded.

The various programs executed in the self POS of the present exemplary embodiment may be recorded on a computer readable recording medium such as a CD-ROM, a flexible disc (FD), a CD-R, or a digital versatile disk (DVD), and may be provided in a file with an installable format or an executable format. The programs may be read to a flash ROM or the like of the self POS and may be executed.

In addition, the programs may be stored on a computer connected to a network such as the Internet, and may be downloaded via the network, so as to be provided.

The above-described respective exemplary embodiments are directed to decrease influence of irradiation light of the infrared device, which is used to detect merchandise or to trigger turning-on and turning-off of a standby mode. However, the irradiation of the infrared is not limited to the purpose, and may be applied to other purposes. For example, the infrared may be used for measuring a distance to merchandise. In this case as well, the same effect may be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sales data processing apparatus comprising:
an imaging unit configured to acquire an image of an item to be purchased that is placed in an imaging region and generate image data of the image;
a light emitting unit configured to emit an infrared light towards the imaging region; and
a control unit configured to identify the item based on the generated image data, and limit an amount of the infrared light that is incident on the imaging region when the imaging unit acquires the image.

2. The sales data processing apparatus according to claim 1, wherein
the control unit limits the amount of the infrared light by turning off the light emitting unit.

3. The sales data processing apparatus according to claim 2, wherein
the control unit is further configured to turn off the imaging unit after the imaging unit has acquired the image.

4. The sales data processing apparatus according to claim 1, further comprising:
a light blocking member, wherein
the control unit limits the amount of the infrared light by causing the light blocking member to block the infrared light emitted by the light emitting unit.

5. The merchandise sales data processing apparatus according to claim 1, wherein
the infrared light reflected by the item placed in the imaging region is incident on the imaging unit.

6. The sales data processing apparatus according to claim 1, wherein
the control unit is further configured to increase the amount of the infrared light incident on the imaging region after the imaging unit has acquired the image.

7. The sales data processing apparatus according to claim 1, wherein
the light emitting unit includes a light emitting element and a first resistor connected in series between a first terminal and a second terminal, and a second resistor and a switching element connected in series and in parallel to the first resistor.

8. An imaging apparatus comprising:
an imaging unit configured to acquire an image of an obj ect placed in an imaging region and generate image data of the image;
a light emitting unit configured to emit an infrared light towards the imaging region; and
a control unit configured to identify the object based on the generated image data and limit an amount of the infrared light incident on the imaging region when the imaging unit acquires the image.

9. The imaging apparatus according to claim 8, wherein
the control unit limits the amount of the infrared light by turning off the light emitting unit.

10. The imaging apparatus according to claim 9, wherein
the control unit is further configured to turn off the imaging unit after the imaging unit has acquired the image.

11. The image acquiring apparatus according to claim 8, further comprising:
a light blocking member, wherein
the control unit limits the amount of the infrared light by causing a light blocking member to block the infrared light emitted by the light emitting unit.

12. The imaging apparatus according to claim 8, wherein
the infrared light reflected by an object placed in the imaging region is incident on the imaging unit.

13. The imaging apparatus according to claim 8, wherein
the control unit is further configured to increase the amount of the infrared light incident on the imaging region after the imaging unit has acquired the image.

14. The imaging apparatus according to claim 8, wherein
the light emitting unit includes a light emitting element and a first resistor connected in series between a first terminal and a second terminal, and a second resistor and a switching element connected in series and in parallel to the first resistor.

15. A method for checking out an item to be purchased using a checkout terminal having an imaging unit and a light emitting unit configured to emit an infrared light towards the item, comprising:
acquiring an image of an item to be purchased that is placed in an imaging region and generating image data of the image, using the imaging unit;
identifying the item based on the generated image data;
acquiring merchandise information associated with the identified item; and
limiting an amount of the infrared light when the acquiring of the image is carried out.

16. The method according to claim 15, wherein
the limiting includes turning off the light emitting unit.

17. The method according to claim 16, further comprising:
turning on the imaging unit in accordance with the infrared light being limited, when the acquiring of the image is carried out.

18. The method according to claim 16, wherein
the limiting includes blocking the emitted infrared light.

19. The method according to claim 15, further comprising:
the infrared light reflected by the item placed in the imaging region is incident on the imaging unit.

20. The method according to claim 15, further comprising:
increasing the infrared light incident on the imaging region after the imaging unit has acquired the image.
